(19) United States
(12) Patent Application Publication
(10) Pub. No.: US 2003/0167196 A1
(43) Pub. Date: Sep. 4, 2003

(54) Method and system for generating computer training enrollment leads

(76) Inventor: Zafar Khizer, Parsippany, NJ (US)

Correspondence Address: LARRY J. GUFFEY, WORLD TRADE CENER - SUITE 1800, 401 EAST PRATT STREET, BALTIMORE, MD, 21202, US

(21) Appl. No.: 09/854,237

(22) Filed: Sep. 17, 2001

(51) Int. Cl. G06F 17/60

(52) U.S. Cl. 705/10

(57) ABSTRACT

The present invention is a method and system for utilizing a distributed network of computers to generate enrollment leads that identify prospective computer training enrollees. The method involves creating a website that promotes the concept of computer aptitude and invites visitors to the website to register online to check their computer aptitude. The registration data is saved and forms the basis of the desired enrollment leads. The leads generated using this method and system are more qualified and less expensive as compared to other lead generation methods currently used in the industry.

### BACKGROUND OF THE INVENTION

1. Field of the Invention

The present invention relates to business practices. More particularly, this invention relates to a system and method for identifying those who would be likely candidates to enroll for computer education and training courses.

2. Description of the Related Art

In the career training or education industry, many varied methods are used to identify those individuals who are most likely to respond positively when solicited to enroll in education or training courses (i.e., enrollment leads). The most common methods for generating such leads are by the use of various types of advertising materials, including advertisements on printed media, television, radio, Internet banners, and by the use of telemarketing techniques.

Another very popular method of lead generation is by sending direct mail to a randomly selected group of people and inviting them to either call or mail a reply card to get more information about a particular field(s) of education or training. A response rate of 0.5% or better is considered good for such mailings. Meanwhile, the percentage of such leads that can actually be converted into student enrollments (i.e., the closing rate) varies greatly depending on the type of educational or training program for which students are being sought.

Even these relatively low percentages for generating leads can usually be achieved only when seeking enrollees for generalized education or training, such as those leading to a two-year business degree or generalized “office application” training. Such percentages have generally not been achieved when trying to generate leads for intensive, specialized training, such as computer career training.

It is generally thought that many people do not respond to such direct mail, marketing appeals for computer career training because they are either intimidated by computers or are not sure if they can successfully complete such training courses. The computer training industry clearly needs better ways to effectively address these concerns of their prospective students.

The currently used marketing methods of the computer training industry are generally quite ineffective when measured by the percentages of responses to their attempts to generate sales leads or by the closing rates achieved when working with such leads. Those in the computer training industry generally pay a high cost per student for their students recruited with current marketing methods. This situation exists because those in the industry focus mostly on advertising their various computer training programs, while not spending any effort or funds to try to encourage prospective students to assess their “computer aptitude.”

The computer training industry greatly needs new and improved, cost-effective methods for generating high quality (i.e., high closure rate) enrollment leads. The opportunity exists for one to create a new, novel type of business that would seek to answer this need—a service business for the computer training industry whose objective would be to supply this industry with cost-effective, high quality, enrollment leads.

### SUMMARY OF THE INVENTION

The present invention is generally directed to satisfying the needs set forth above and overcoming the limitations and problems identified with prior systems and methods for generating cost-effective, high quality enrollment leads for the computer training industry.

In accordance with one preferred embodiment, the present invention takes the form of a method for utilizing the Internet to provide enrollment leads that identify prospective computer training enrollees. It is seen to be comprised of the steps of: (a) establishing a website on the Internet, (b) promoting on the website the measuring of one's computer aptitude, (c) establishing a test that measures one's computer aptitude, (d) providing the means on the website for a visitor to the website to register, by entering identifying information such as name, address, telephone number, email address, etc., to apply to take a test that measures one's computer aptitude, (e) storing the inputted, identifying data, which is then used to make of the basics of the desired enrollment lead, (f) in response to the applicant's registration, providing the registrant with a user ID and password that allows the registrant to use any networked computer on which to take the desired computer aptitude test online, (g) in response to the entry of the registrant's user ID and password, displaying on the registrant's video screen the test that measures one's computer aptitude, and (h) evaluating the registrant's performance on the test and communicating this evaluation to the registrant, wherein the collected registration data comprises the desired enrollment lead.

In accordance with another preferred embodiment of the present invention, a system for utilizing a distributed network of computers, of the type having video displays and keyboards, to generate computer training enrollment leads, comprises: (a) a website on the distributed network, (b) means for promoting on the website the measuring of one's computer aptitude, (c) a test that measures one's computer aptitude, (d) means on the website for a visitor accessing the website to input registration data that identifies the visitor so as to register the visitor to apply to take the test that measures one's computer aptitude, (e) means for storing the inputted, registration data, (f) means for displaying, in response to the visitor's registration, on the video screen of the accessing computer of the registrant, the test that measures one's computer aptitude, and (g) means for evaluating the registrant's performance on the test and communicating this evaluation to the registrant, wherein the inputted registration data comprises the desired enrollment lead.

The present invention is seen to overcome the limitations of the prior art. It is therefore an object of the present invention to provide an improved, cost-effective method and system for generating high quality (i.e., high closure rate) enrollment leads for computer training.

It is another object of the present invention to create a new, novel type of service business for the computer training industry; the objective of this service business being to supply this industry with cost-effective, high quality enrollment leads.

It is a yet another object of the present invention to provide a method and system that allows computer training entities to effectively address the concerns of their prospective students regarding their possibilities for success in computer training programs.

These and other objects and advantages of the present invention will become readily apparent as the invention is better understood by reference to the accompanying drawings and the detailed description that follows.

### BRIEF DESCRIPTION OF THE DRAWINGS

FIG. 1 illustrates the basic steps involved in a method for providing the service of supplying a computer training entity with enrollment leads.

FIG. 2 illustrates the typical computer hardware for use in implementing the present invention.

FIG. 3 shows a block diagram for a representative computer for use implementing the present invention.

FIG. 4 is a schematic representation of an exemplary web page that may be used to facilitate the present invention's method of generating enrollment leads.

FIG. 5 illustrates the type of interactive, registration form that may be found on a website that is used to practice the present invention.

FIG. 6 illustrates the type of email that may be sued to facilitate the applicant's use of a login ID and password to access the computer aptitude test.

FIG. 7 illustrates the printout for a possible Enrollment Leads Report.

FIGS. 8a-8e illustrates the typical computer aptitude test that may be used with the present invention.

### DESCRIPTION OF THE PREFERRED EMBODIMENT

For purposes of explanation and not limitation, specific details are set forth below, such as web page designs and computer aptitude test questions, in order to provide a thorough understanding of the present invention. However, it will be apparent to one skilled in the art that the present invention may be practiced in other embodiments that depart from these specific details. In other instances, detailed descriptions of well known, testing and website development methods, etc. are omitted so as not to obscure the description of the present invention with unnecessary detail.

Referring now to the drawings wherein are shown preferred embodiments and wherein like reference numerals designate like elements throughout, there is shown in these drawings the various aspects of a method and system for generating computer training, enrollment leads.

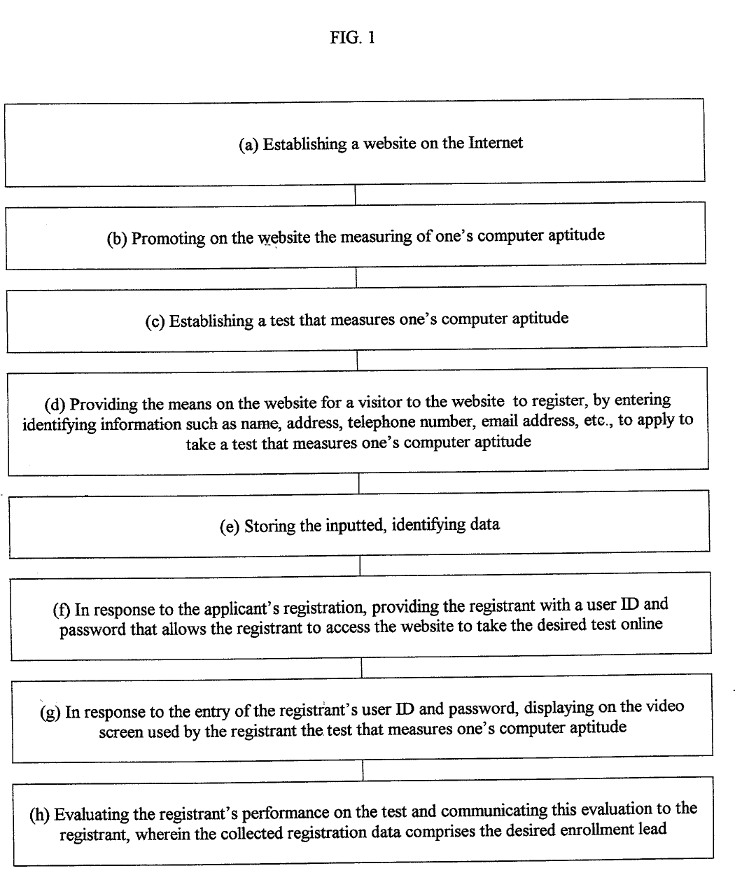

As represented in FIG. 1, one embodiment of the present invention takes the form of a method for utilizing the Internet to provide enrollment leads that identify prospective computer training enrollees. It is seen to be comprised of the steps of: (a) establishing a website on the Internet, (b) promoting on the website the measuring of one's computer aptitude, (c) establishing a test that measures one's computer aptitude, (d) providing the means on the website for a visitor to the website to register, by entering identifying information such as name, address, telephone number, email address, etc., to apply to take a test that measures one's computer aptitude, (e) storing the inputted, identifying data, (f) in response to the applicant's registration, providing the registrant with a user ID and password that allows the registrant to use any networked computer on which to take the desired test online, (g) in response to the entry of the registrant's user ID and password, displaying on the video screen used by the registrant the test that measures one's computer aptitude, and (h) evaluating the registrant's performance on the test and communicating this evaluation to the registrant, wherein the collected registration data comprises the desired enrollment lead.

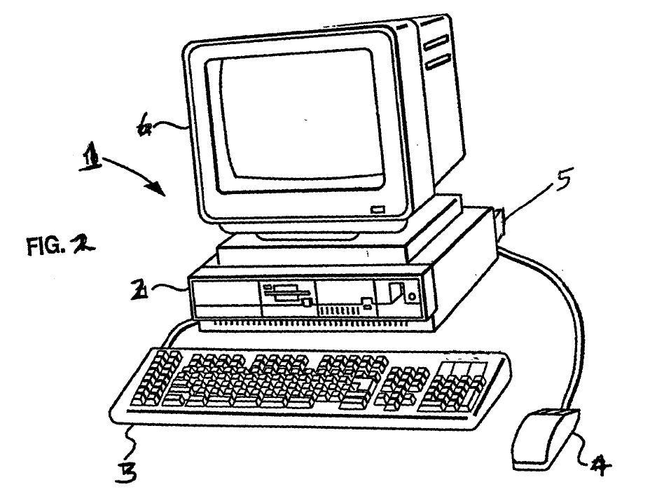

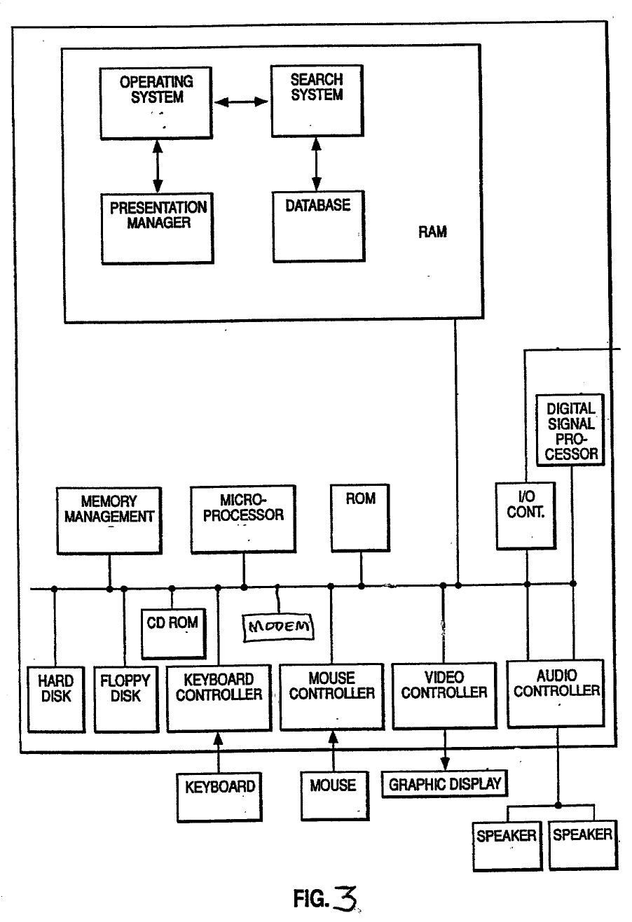

FIG. 2 illustrates the typical components of an Internet-linked computer. Such a computer 1 is seen to include a system unit 2, a keyboard 3, a mouse 4, a modem 5 and a video display 6. FIG. 3 shows a typical block diagram for such a computer. It includes a system bus or plurality of system buses to which various components are coupled and by which communication between the various components is accomplished. The microprocessor or central processing unit (CPU) is connected to the system bus and is supported by read only memory (ROM) and random access memory (RAM) also connected to system bus. The ROM contains among other code the Basic Input-Output system (BIOS) which controls basic hardware operations such as the interaction and the disk drives and the keyboard. The RAM is the main memory into which the operating system and application programs are loaded. The memory management chip is connected to the system bus and controls direct memory access operations including, passing data between the RAM and hard disk drive and floppy disk drive. The CD ROM, also coupled to the system bus, is used to store a large amount of data, e.g., a multimedia program or large database.

Also connected to this system bus are various I/O controllers: the keyboard controller, the mouse controller, the modem controller, the video controller, and the audio controller. The keyboard controller provides the hardware interface for the keyboard, the mouse controller provides the hardware interface for the mouse (or other point and click device), the modem provides access to the Internet and enables communication to other similarly configured data processing systems, the video controller is the hardware interface for the video display, and the audio controller is the hardware interface for any multimedia speakers.

Another preferred embodiment of the present invention takes the form of a system for utilizing a distributed network of computers, such as those shown in FIGS. 1-2, to generate computer training enrollment leads. In general, such a system is comprised of the means for achieving each of the process steps listed in the initially listed method. As is widely known in the art, these will in most cases take the form of software that is written to, or integrated circuits that are designed to, perform each of the listed steps.

To drive prospective computer training enrollees to the website, advertisements may be placed in newspapers, on television, radio, billboards, etc. Examples of the banner lines for such advertisements are illustrated below:

“Do you qualify for a computer career? Check Free at www.ComputerAptitude.com”

“got IT? Check Free at www.ComputerAptitude.com”

“What is your Computer I.Q.? Check Free at www.ComputerAptitude.com”

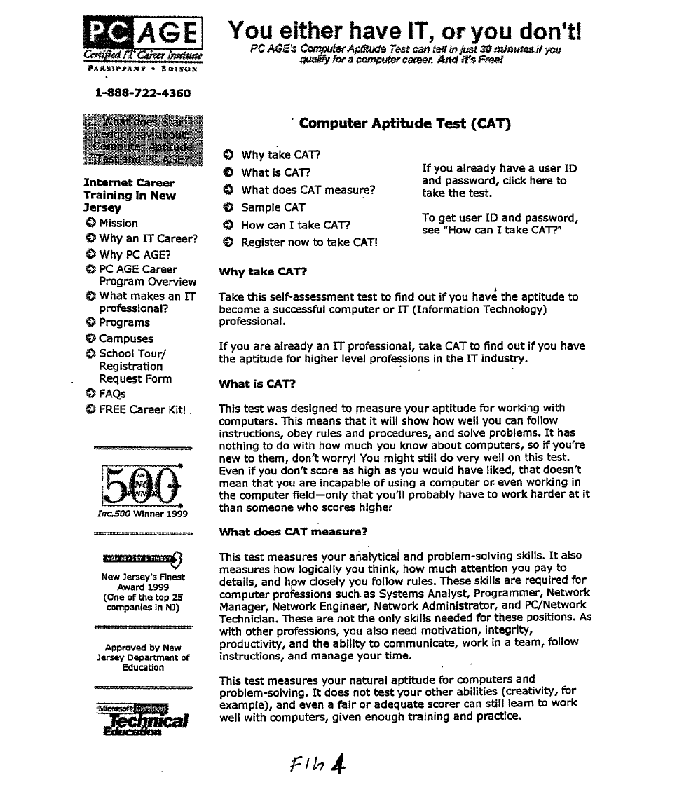

FIG. 4 provides an example of how one might design the home page of such a www.ComputerAptitude.com website. This website is seen to provide a detailed description of such a computer aptitude test and to explain to a website visitor what such a test measures. This website is further seen to be designed so as to make the website visitor comfortable by declaring that the test measures one's computer aptitude and not one's knowledge of computers and their use.

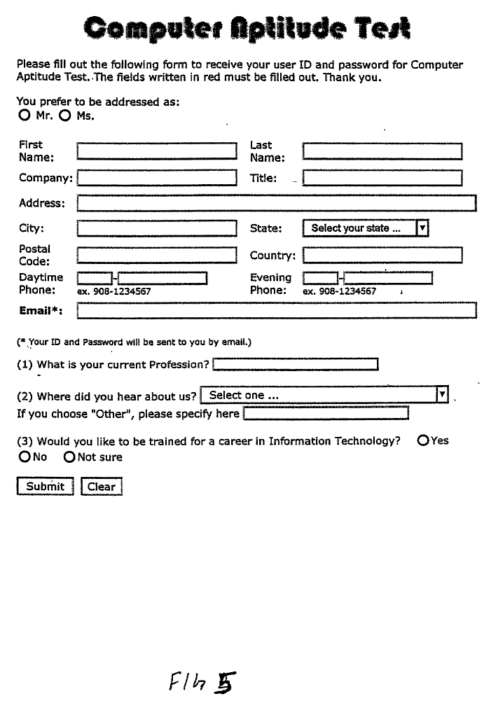

The website provides a visitor with the option of applying to register to take such a computer aptitude test. Registration is accomplished by having the website visitor fill out an interactive, registration form or questionnaire, see FIG. 5, that is projected on the visitor's video display and collects information such as the applicant's name, address, telephone number, email address, etc. It also can ask other computer training related questions to further qualify the applicant; questions such as “Do you want to be trained for a computer career?”

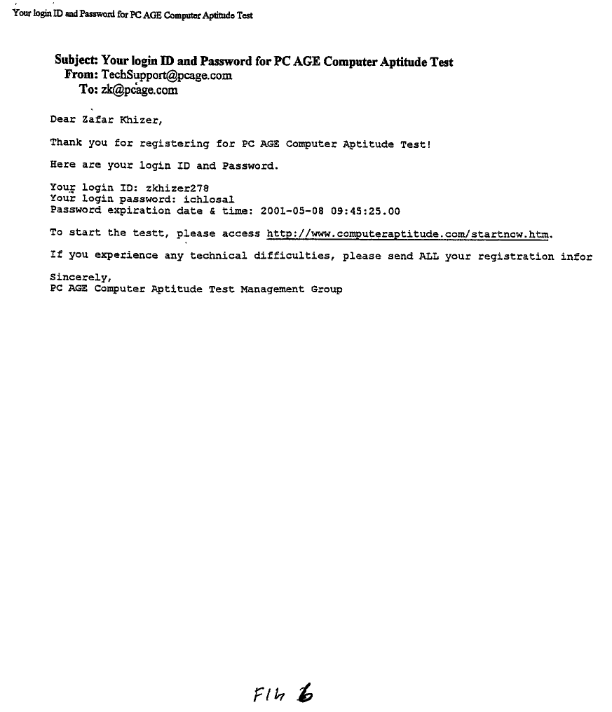

After receiving the required information, a user ID number and password are quickly emailed to the applicant. This provides a check on the accuracy of the email information that an applicant has provided. FIG. 6 provides an example of such an email message.

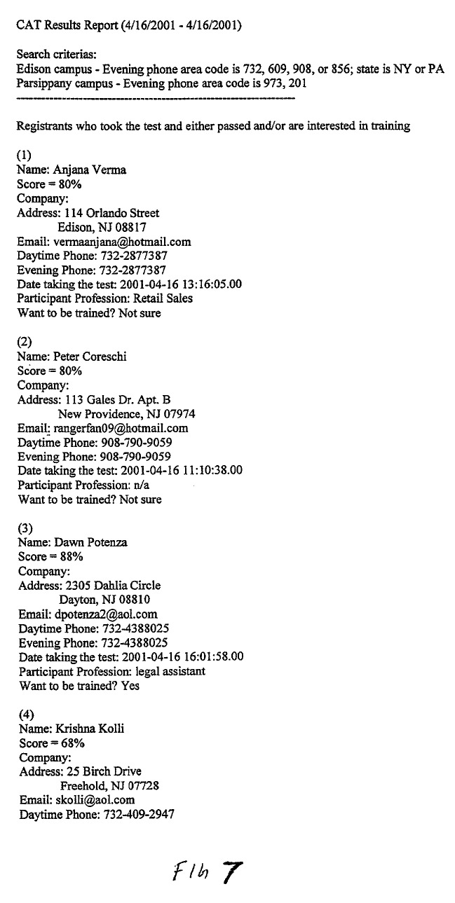

An applicant's registration or identifying information or data (i.e., enrollment leads) is stored in a database such as Microsoft Access or SQL database. This data can be sorted according to any number of needs of one wishing to use such leads. For example, this data may be sorted by area codes that are within a specified vicinity of a computer training entity and an Enrollment Leads Report can be constructed which clearly communicates information on the prospective, computer training enrollees. See FIG. 7.

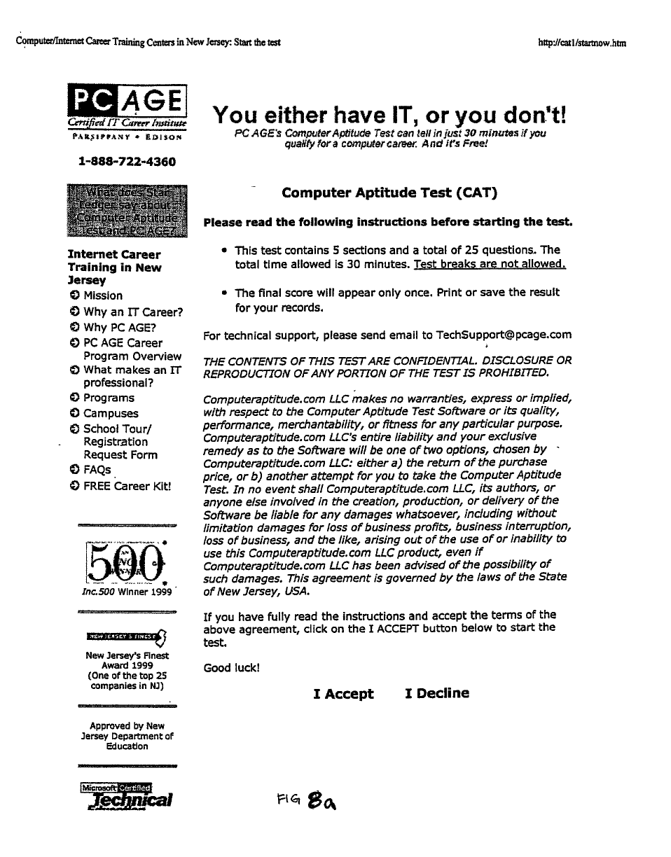

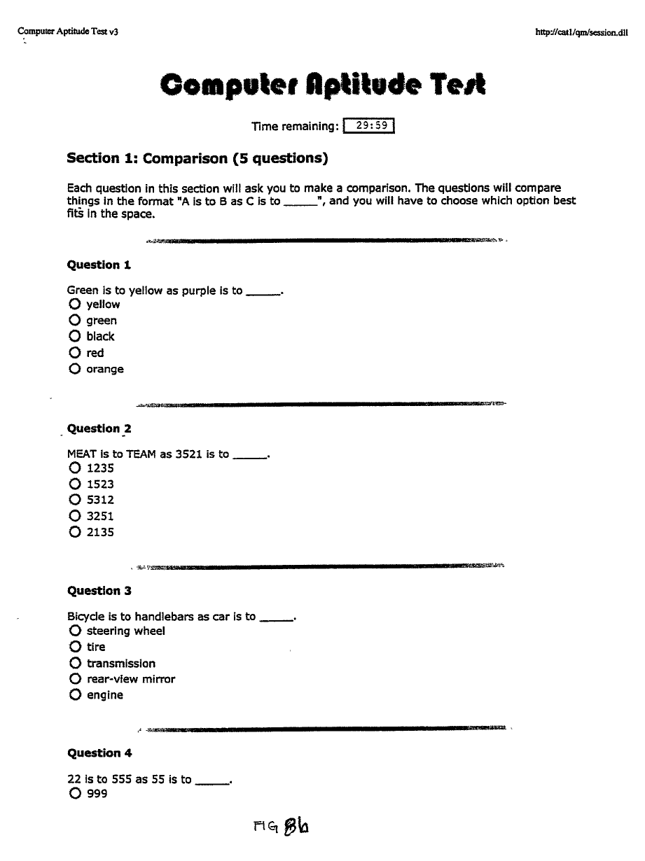

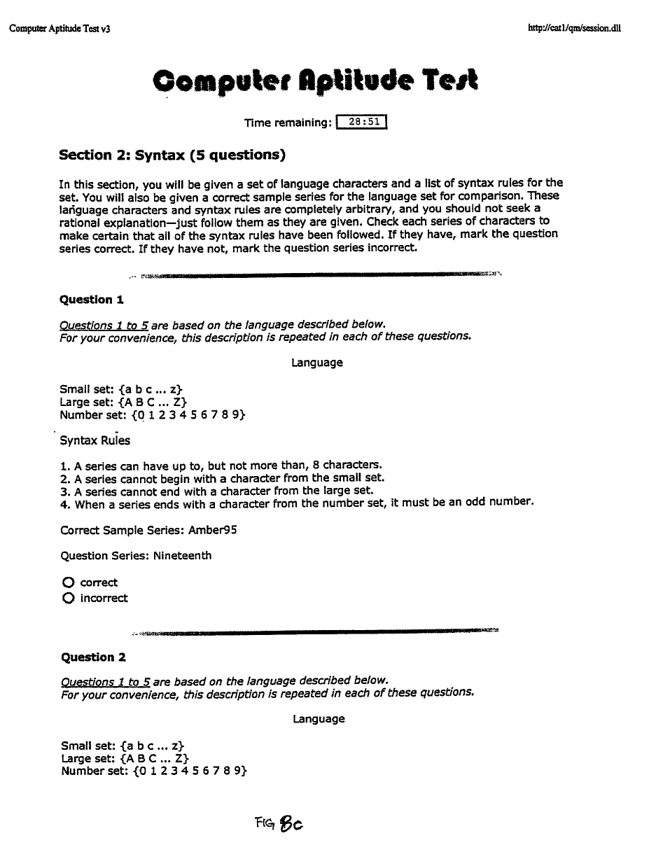

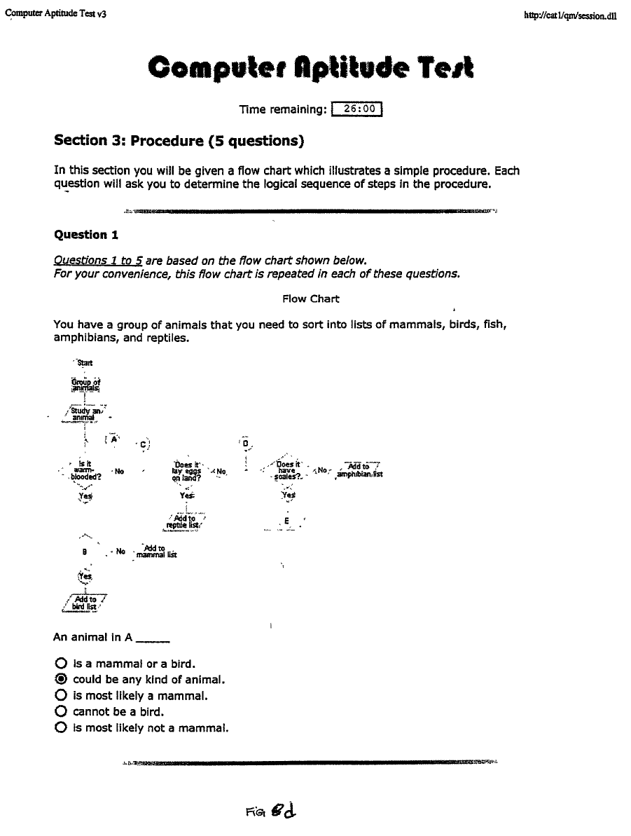

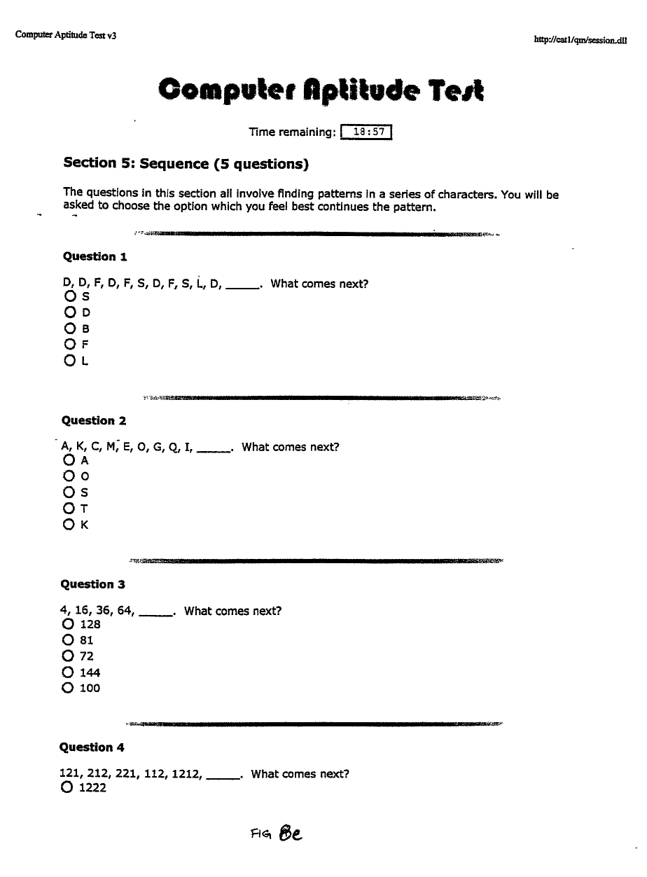

Commercially available software and technology may be used to present the computer aptitude test questions, to calculate an applicant's score, and to make sure multiple people can take the test at the same time using the same website. FIG. 8 provides a copyrighted example of the type of computer aptitude test that would be available at the website. This test was designed by the applicant's computer training company and was scientifically validated by a third party to ensure that it accurately provides a reliable evaluation of one's computer aptitude.

This sample test is seen to consist of a plurality of multiple-choice questions that must be answered in a specified time period. The individual questions are seen to be from the group of those which seek to measure one's skills of pattern recognition, comprehension of syntax rules, comprehension of flow chart procedures, and recognition of relationships between elements.

The foregoing descriptions of the invention have been presented for purposes of illustration and description. Further, the description is not intended to limit the invention to the form disclosed herein. Consequently, variations and modifications commensurate with the above teachings, and combined with the skill or knowledge in the relevant art are within the scope of the present invention.

The preferred embodiments described herein are further intended to explain the best mode known of practicing the invention and to enable others skilled in the art to utilize the invention in various embodiments and with various modifications required by their particular applications or uses of the invention. It is intended that the appended claims be construed to include alternate embodiments to the extent permitted by the current art.

I claim:

1. A method for utilizing a distributed network of computers, having video displays and keyboards, to provide enrollment leads that identify prospective, computer training enrollees, said method comprising the steps of:
establishing a website on said distributed network,
promoting the measuring of one's computer aptitude,
establishing a test that measures one's computer aptitude,
providing the means on said website for a visitor accessing said website to input registration data that identifies said visitor so as to register said visitor to apply to take said test that measures one's computer aptitude,
storing said inputted, registration data,
displaying, in response to said visitor's registration, on the video screen used by the registrant said test that measures one's computer aptitude, and
evaluating the registrant's performance on said test, and
communicating said evaluation to said registrant,
wherein said registration data comprises said enrollment lead.

2. A method as recited in claim 1, wherein said distributed network is the Internet.

3. A method as recited in claim 1, wherein said test comprising a plurality of multiple-choice questions that must be answered within a specified period of time.

4. A method as recited in claim 2, wherein said test comprising a plurality of multiple-choice questions that must be answered within a specified period of time.

5. A method as recited in claim 3, wherein said questions are chosen from the group consisting of those directed to measuring one's skills of pattern recognition, comprehension of syntax rules, comprehension of flow chart procedures, and recognition of relationships between elements.

6. A method as recited in claim 4, wherein said questions are chosen from the group consisting of those directed to measuring one's skills of pattern recognition, comprehension of syntax rules, comprehension of flow chart procedures, and recognition of relationships between elements.

7. A method as recited in claim 1, wherein said means for registering comprising a means for displaying a registration questionnaire on said video screen for said visitor to answer using said keyboard, and a means for providing, upon completion of said questionnaire, said visitor with a user ID and password.

8. A method as recited in claim 2, wherein said means for registering comprising a means for displaying a registration questionnaire on said video screen for said visitor to answer using said keyboard, and a means for providing, upon completion of said questionnaire, said visitor with a user ID and password.

9. A method as recited in claim 1, further comprising the step of:
collecting said inputted, registration data for a plurality of website visitors, and
contracting with a computer training entity to provide said entity with said collected registration data for plurality of website visitors.

10. A method as recited in claim 2, further comprising the step of:
collecting said inputted, registration data for a plurality of website visitors, and
contracting with a computer training entity to provide said entity with said collected registration data for plurality of website visitors.

11. A system for utilizing a distributed network of computers, having video displays and keyboards, to generate computer training enrollment leads, said system comprising:
a website on said distributed network,
means for promoting on said website the measuring of one's computer aptitude,
a test that measures one's computer aptitude,
means on said website for a visitor accessing said website to input registration data that identifies said visitor so as to register said visitor to apply to take said test that measures one's computer aptitude,
means for storing said inputted, registration data,
means for displaying, in response to said visitor's registration, on the video screen of the accessing computer of said registrant, said test that measures one's computer aptitude, and
means for evaluating the registrant's performance on said test,
means for communicating said evaluation to said registrant,
wherein said registration data comprises said enrollment lead.

12. A system as recited in claim 11, wherein said distributed network is the Internet.

13. A system as recited in claim 11, wherein said test comprising a plurality of multiple-choice questions that must be answered within a specified period of time.

14. A system as recited in claim 12, wherein said test comprising a plurality of multiple-choice questions that must be answered within a specified period of time.

15. A system as recited in claim 13, wherein said questions are chosen from the group consisting of those directed to measuring one's skills of pattern recognition, comprehension of syntax rules, comprehension of flow chart procedures, and recognition of relationships between elements.

16. A system as recited in claim 14, wherein said questions are chosen from the group consisting of those directed to measuring one's skills of pattern recognition, comprehension of syntax rules, comprehension of flow chart procedures, and recognition of relationships between elements.

17. A system as recited in claim 11, wherein said means for registering comprising a means for displaying a registration questionnaire on said video screen for said visitor to answer using said keyboard, and a means for providing, upon completion of said questionnaire, said visitor with a user ID and password.

18. A system as recited in claim 12, wherein said means for registering comprising a means for displaying a registration questionnaire on said video screen for said visitor to answer using said keyboard, and a means for providing, upon completion of said questionnaire, said visitor with a user ID and password.
